(19) United States
(12) Patent Application Publication
(10) Pub. No.: US 2009/0028372 A1
(43) Pub. Date: Jan. 29, 2009

(54) LIGHT FIXTURE WITH SOUND CAPABILITY

(75) Inventor: Mark Cerasuolo, Redmond, WA (US)

Correspondence Address: Weiss & Arons, LLP, 1540 Route 202, Suite 8, Pomona, NY, 10970, US

(73) Assignee: Leviton Manufacturing Co., Inc., Little Neck, NY (US)

(21) Appl. No.: 11/781,724

(22) Filed: Jul. 23, 2007

(51) Int. Cl. H04R 1/02

(52) U.S. Cl. 381/387

(57) ABSTRACT

An apparatus that enhances the functionality of a fixture is provided. The fixture may include a light. The light may include an illuminating portion. The fixture may also include a loudspeaker. The fixture may also include a casing that houses at least a substantial portion of the loudspeaker. The casing may also include a slot adapted to allow the sound to be transmitted from the loudspeaker to a surrounding area. The slot may be disposed between the loudspeaker and the illuminating portion of the light. Finally, the fixture may include a sound diffuser. The sound diffusor can preferably direct sound from the loudspeaker radially outward through the slot. In an alternative embodiment the fixture may include a tan in addition to, or instead of, the light.

### BACKGROUND OF THE INVENTION

This application relates to introducing new functionality to light fixtures and/or other electrical fixtures such as a fan fixture or other suitable fixture. It should be noted that all references to light fixtures herein may be understood to include ceiling-mounted light fixtures, other suitable light fixtures such as fan/light fixtures or non-ceiling mounted fixtures and/or other suitable electrical fixtures such as fan fixtures. Specifically, this application relates to expanding the functions of conventional light fixtures, or other conventional utilitarian fixtures, from functions such as providing light and enhancing air circulation via a fan to other functions. This invention also relates to a method for adapting light fixture (or other suitable fixture) housings for alternative functionalities.

### SUMMARY OF THE INVENTION

The sound-plus-vision fixture according to the invention is designed to accommodate the distribution and reproduction of distributed full-range audio signals throughout a home or small business without dedicated low-voltage wiring. In one embodiment, the invention may include a self-contained, amplified module that simply requires a power-line connection to receive an audio signal. In one embodiment of the invention, the fixture may incorporate sound and vision elements.

An apparatus according to the invention may include a light. The light may include an illuminating portion. The apparatus may also include a single loudspeaker, a pair of loudspeakers or an isobaric pair of loudspeakers or some other suitable arrangement of loudspeakers. The apparatus may additionally include a casing that houses the loudspeakers. The casing may be constructed with a slot. The slot according to the invention may be adapted to allow the sound to be transmitted from the loudspeakers to a surrounding area. The slot may be disposed between the loudspeakers and the illuminating portion of the light. The invention may also include a sound diffusor. The sound diffusor may be configured to direct sound from the loudspeakers radially outward through the slot.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 shows a side-view of a schematic illustration of a fixture according to the invention.

FIG. 2 shows a sectional perspective view of a loudspeaker for use in a system according to the invention.

FIG. 3 shows a system according to the invention.

FIG. 4 shows a ceiling light kit according to the invention.

FIG. 5 shows a ceiling fan kit according to the invention.

FIG. 6 shows a ceiling kit according to the invention.

### DETAILED DESCRIPTION OF THE INVENTION

Retrofitting installed audio systems in an existing structure is extremely labor-intensive. The primary labor requirement in retrofitting these systems is running required speaker wiring or other dedicated low-voltage audio signal wiring such as Category-5 cable for an A-bus system, as is known in the art over long horizontal distances.

However, power-line access is typically always available in every room, inside nearly every wall, and in many ceilings with lighting fixtures. For example, a ceiling fixture is common in master bedrooms, dining rooms and other locations. Furthermore, in many older homes these ceiling fixtures may be “capped” in favor of a lamp and other lighting, but are ready for use if needed.

It is well known that ceiling lighting fixtures are often upgraded. In fact, the common upgrades are the driving force behind the extensive lighting departments found in many hardware stores. Upgrade kits can include combination lighting/ceiling fans and chandeliers. These commercially available upgrade kits often require a control upgrade as well. One embodiment of a system according to the invention may preferably be offered as a possible upgrade for a typical light fixture (or other suitable fixture). Such a system may integrate a room lighting upgrade with an entertainment system addition as will be explained in more detail below.

While amplified and “networkable” speakers such as speakers with networking cards and IP addressability, from, for example, Atlantic Technologies of Norwood, Mass., and others, have been attempted before, these were conventional installed stereo speakers and required dedicated power supply wiring. These speakers were often difficult to install and address, and extremely expensive.

One embodiment of a fixture according to the invention preferably incorporates a tuned acoustical enclosure. The enclosure preferably houses both the speaker complement and on-board electronics. On-board electronics may include an amplifier, a signal processor, and a power-line audio and control signal receiver.

In certain embodiments, the invention may include a combination of the following three features:

1. Power-line audio signal distribution and on-board amplification—a dedicated send/TX (transmission) unit (such a unit is produced commercially by such as powerline TX/RX modules produced by Arkados, Inc. of Piscataway, N.J., can be located near an entertainment center. The TX unit preferably feeds a line-level audio signal—i.e., a signal that transmits analog sound information between audio components—over the available power-lines. With respect to this aspect of the invention, two embodiments of this unit are proposed: a single-source unit and a multi-source selectable version, the source selection that can be remotely controlled. A fixture according to the invention may contain a complementary receive/RX (receiving) unit as pail of its on-board electronics package. This package also may include a relatively high-power audio amplifier of appropriate design for in-ceiling or in-wall installation, preset or definable system equalization, and control signal electronics for using a remote or keypad to raise/lower volume and effect any source selection or other functions. An additional benefit of using AC at the speaker is that the AC Hoe also provides the ability to power an add-on lighting fixture and/or ceiling fan.

2. Isobaric speakers for use in an Isobaric enclosure (for the purposes of this application, the term isobaric refers to the use of two woofers (bass drivers) in an enclosed loudspeaker unit)—the use of a second internal woofer effectively doubles bass output for a given enclosure size. An isobaric enclosure preferably optimizes the single ceiling-speaker location and ensures sufficient acoustical output. Isobarics are usually found in advanced automotive sound and stand-alone compact subwoofer applications where both performance and size have to be reconciled. In these situations, the extra cost of a second transducer and additional amplifier power is worth the benefit of being able to shrink the enclosure size in half. In the present invention as well, size is an important factor because the volume of the light fixture (or other suitable fixture) is relatively limited and the volume available to be used as a loudspeaker is accordingly relatively small. As such, a fixture according to the invention may also utilize a second transducer and provide additional amplifier power (especially in view of the readily available power from the AC line) in exchange for being able to shrink the enclosure size in half.

3. Radial Diffuser array—One challenge in mounting a light or fan under a conventional ceiling speaker is that the light or fan (or other suitable device) may interfere with the output of the speaker itself because, in such configurations, conventional speakers fire downward (or, in other embodiments, directly outward from the wall in which the speakers are mounted). The design according to the invention preferably adapts diffuser array technology to effectively optimize horizontal output throughout a listening area. In this particular embodiment of the invention, this technology obtains the dual benefit of maneuvering sound output around any obstruction underneath the speaker while also evenly distributing it throughout the room from a single stereo location.

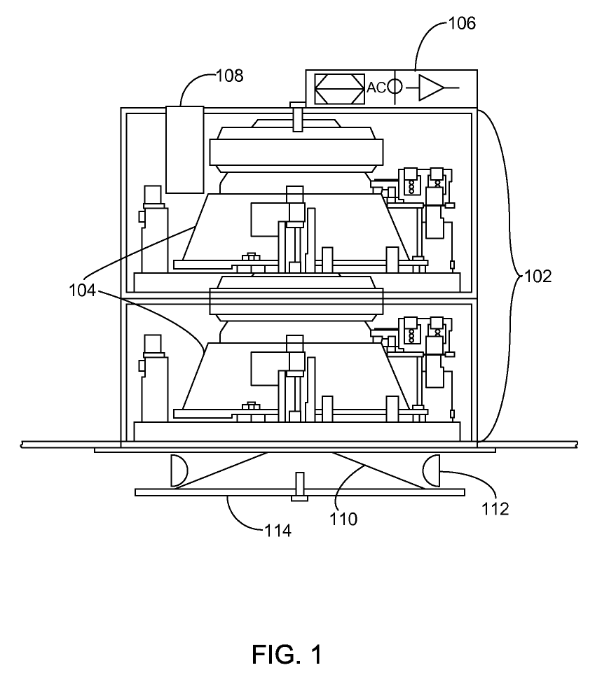

FIG. 1 shows a schematic diagram of a system 100 according to the invention. FIG. 1 preferably includes isobaric enclosure 102 with tandem bass configuration 104, electronics module 106 (which may include a power-line module, a digital amplifier, other digital signal processing such as an auto-Equalizer, and a controller receiver), bandpass port 108, radial sound diffuser 110, high-frequency stereo tweeters 112, and ceiling light/fan mounting platform 114.

The two-chambered enclosure can be rated for ceiling use or other suitable use, with all required safety agency features such as hang points, conduit fittings, etc., not shown in the schematic of FIG. 1.

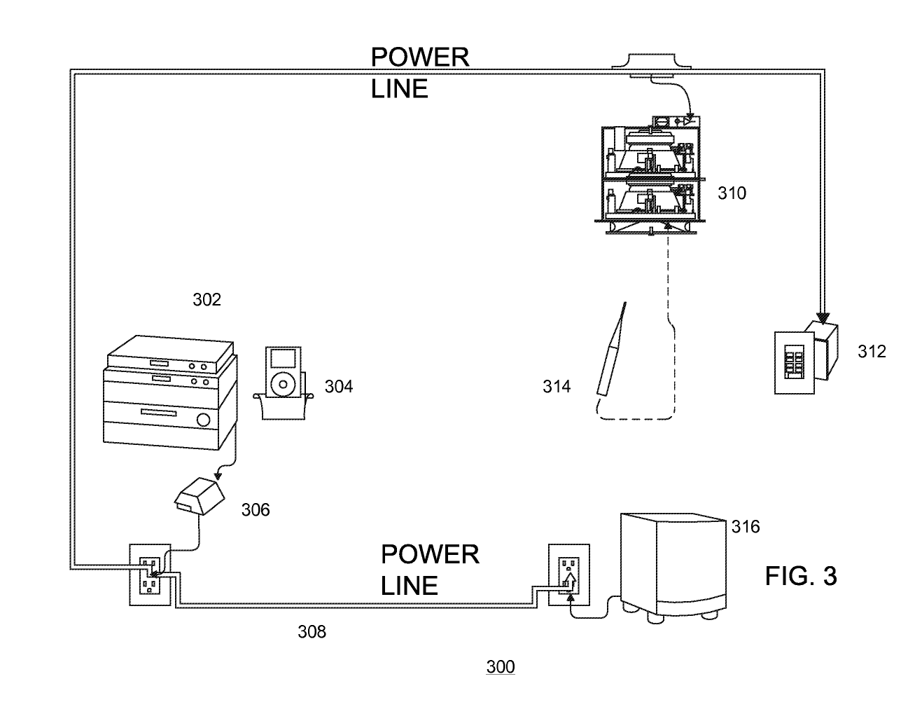

Two-channel high-powered amplification can be implemented in a system according to the invention. Two-channel amplification may power two speakers, as shown in FIG. 1, and a sub-woofer (see FIG. 3). Because AC power is present in a fixture according to the invention, conventional high-current Class AB amplifier technology could be used. Class AB amplifier technology consumes a fixed amount of supply current for the desired output voltage. It should be noted that, in such an embodiment, the amplifier would preferably be required to meet UL and other safety ratings for in-wall use. A 12 or 24 Volt design could be preferable, and that would likely be digital (either Class D or proprietary design) as is set forth in the embodiment that follows.

In one embodiment of the invention, a high-efficiency Class D amplifier or similar is recommended for easier thermal management and safety compliance reasons. Class D amplifier technology, in contrast to a Class-AB audio amplifier, delivers a fixed amount of power into the load for a given period. The increased efficiency of Class D amplification reduces the heat generated by the amplifier and, therefore, may be more advantageous for certain embodiments of the fixture according to the invention.

Electronics module 106 preferably also includes a power-line source signal receiver. This receiver allows for the installation of the speaker inside an existing light fixture (or other suitable fixture) without requiring extra wiring to transmit the signal. This type of receiver is commercially available, as described above.

Electronics module 106 may also include a remote control interface. The remote control interface may be for use with a hand-held remote, wall-mounted volume control or wall-mounted keypad (all are viable options) or other suitable input device.

In addition, electronics module 106 may include digital signal processing. In some embodiments of the invention, the self-contained amplified design obtains unique advantages with respect to digital signal processing. Specifically, an embodiment of the invention preferably enables active equalization and custom-tuning capability for an individual room in which the fixture is located. For example, a plug-in calibrated microphone can be used in combination with a known auto-Equalizer function much like that found in most advanced Audio/Video Receivers (AVRs). The DSP function could also enable using a subwoofer (see FIG. 3) which can be in communication with both the unit, according to the invention, for settings and level-matching, and the audio source for signal.

Control options for controlling the operation of the fixture according to the invention could include a known audio/video source power-line carrier module (AV/PLC) as described above—for transmitting a single source over a whole-house network or, alternatively, a power-line carrier source input selector for the AV system. One embodiment of the invention could implement a switchable component that may enable up to four (or even more) audio sources, as is known, (such as the AE6MC keypad multi-channel amplifier manufactured by Leviton Manufacturing Co., which allows up to seven switchable source inputs) to be transmitted over a power-line system, with different fixtures according to the invention receiving signals from different sources depending on the source selected.

Power-line carrier room controls according to the invention may include at least one of the following devices, although any suitable device can be used. The controls may include a simple wall-mounted volume control, a multi-source keypad, or a hand-held remote. It should be noted that wall-mounted controls can be infra-red (IR) or radio frequency (RF) enabled; but RF is preferable at least because the RF is not subject to line of sight limitations. In one embodiment of the invention, the control does not handle any audio signal but simply controls the on-board amplifier and other assorted electronics, as described in more detail above. Further options for the control can include combination lighting and audio control because the fixture may be installed in place of a light fixture (or other suitable fixture) and be wired for power off the same switch as the previously-installed light fixture (or other suitable fixture). In such an embodiment, the “load” wire could be disabled and any lighting control affected by the RF technology could be built into the optional lighting fixture. Furthermore, new home automation products such as the Acenti™ line of products or the Vizia-RF™ product produced by Leviton Manufacturing Co. could be reconfigured as a battery-operated device because the only controls necessary in such a device are controlling the on-board amplifier and electronics.

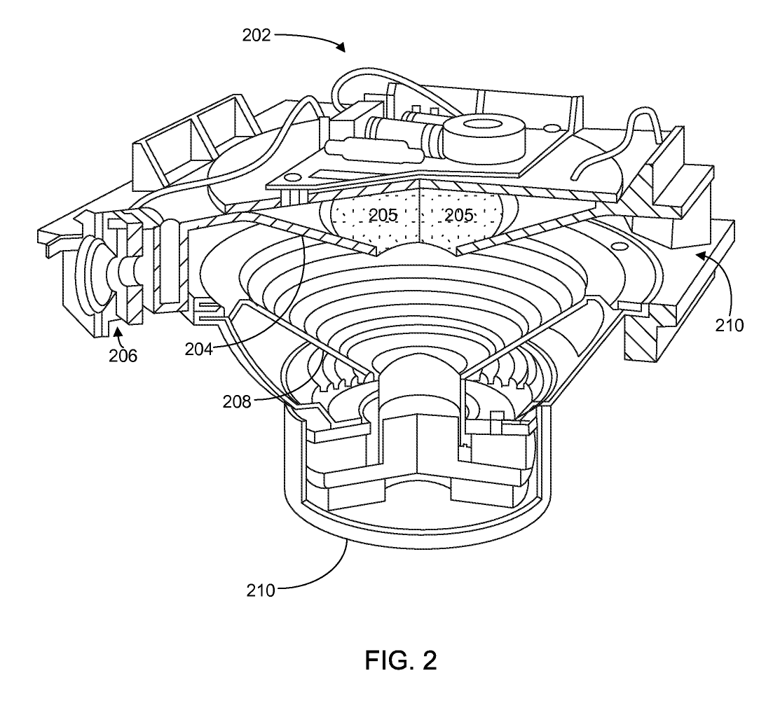

FIG. 2 shows one embodiment of a loudspeaker 200 incorporating radial sound diffusor technology (the speaker in FIG. 2 is not shown using isobaric technology, but rather is only shown to illustrate sound diffusor technology) for use in systems according to the invention. Speaker 200 includes frequency dividing network 202 that divides the received signal into low and high frequency components for distribution among the various speakers (alternatively referred to herein as “drivers”), sound diffusor 204, foam pad 205, high frequency driver (4) 206, a low/mid frequency driver 208, and a magnetic shield 210. Diffusor 204 shapes and transforms the normally direct midrange and high-frequency sound into a toroidal-shaped omnidirectional pattern, preferably evenly spreading it throughout the room through the surrounding slot 212. Diffusor 204 preferably spreads the sound out along a radial axis, thereby substantially avoiding any interference from a light fixture (or other suitable fixture) or a fan mounted below the slot. Diffusor 204 may be formed from a suitably-shaped—e.g., cone-shaped—anti-vibratory material. One example of such an anti-vibratory material are the “plas” coatings manufactured by JBL Inc. of Northridge, Calif., which are known in the art. The diffuser may be lined, at least in part, with a foam pad 207 which promotes the proper diffusion of the sound.

Suitable diffusor technology is described in more detail at the following website, which is incorporated by reference herein in its entirety: www.audioheritage.org/html/profiles/jb1/acquarius.htm. Additional information may also be found at the JBL S119 Designer Series Application Note, which is incorporated by reference herein in its entirety.

FIG. 3 shows a schematic diagram of a system 300 according to the invention. System 300 preferably includes sources 302 and 304 as well as AV/PLC transmission unit 306 for transmitting signals through power line 308. System 300 also includes fixture 310 according to the invention as well as AV/PLC enabled keypad controller 312. Fixture 310 may be tuned using calibrated microphone 314 which may be used in tandem with the equalizer described above to calibrate the diffusion of the sound (The microphone, as part of an active equalization system, may not strictly calibrate diffusion but may calibrate a number of response parameters including equalization, phase, time delay, levels, etc. to compensate for the room-speaker interaction (to which the diffusor contributes to some extent)). Finally, system 300 may also include a subwoofer 316, such as JBL JRX100 Series subwoofer, that is adapted for AV/PLC in a fashion that is known in the art, such as using Arkados technology on an existing JBL-powered subwoofer with modification for level setting and volume control, which can enhance the sound provided.

Possible embodiments of the invention can be home theater versions and/or outdoor versions.

Because of its unique design and its access to both AC and a light switch, the platform according to the invention could further be engineered to accommodate room lighting and even fan mounting, much the same way as do conventional lighting products. This can be a powerful advantage in home-improvement retailing as the product according to the invention can enter an already existing market and capitalize on the market by introducing new functionality in the same space, with a similar form factor.

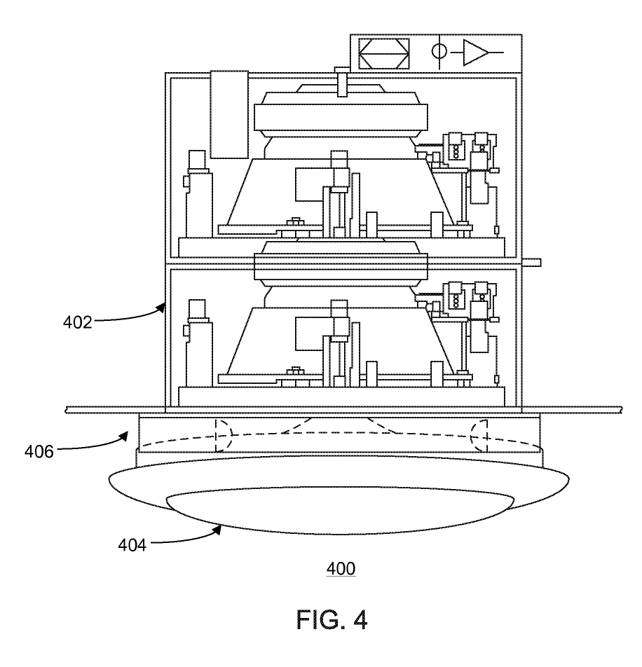

FIG. 4 shows one possible embodiment of a fixture 400 according to the invention. Fixture preferably includes sound module 402 and light 404. Light 404 may include an illuminating portion that is disposed below slot 406. Nevertheless, light 404 may also include a stem (not shown) that may extend in some suitable fashion into the area enclosed by the sound diffusor. In alternative embodiments of the invention, the light may be a flat light, as is known in the art, that doesn't include any portion that extends up into the area enclosed by the sound diffusor.

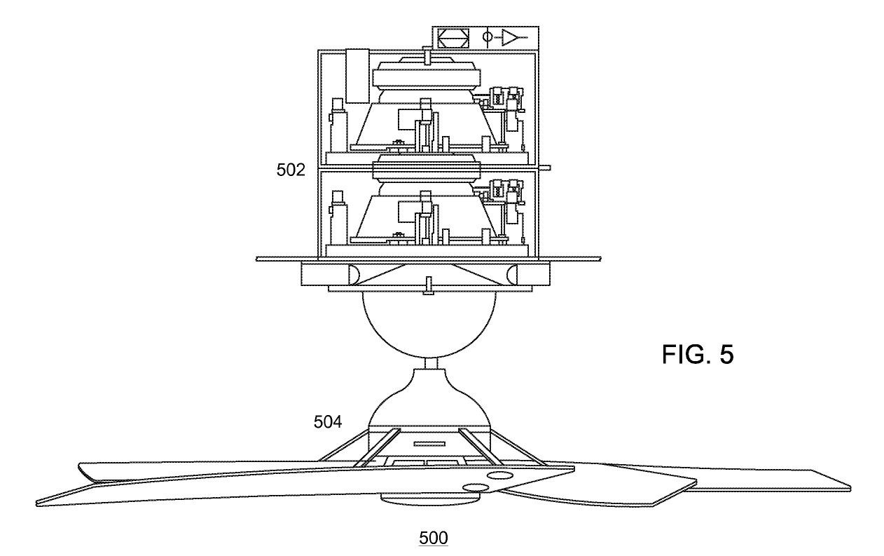

FIG. 5 shows another embodiment of a fixture 500 according to the invention. Fixture 500 includes sound module 502 and fan 504.

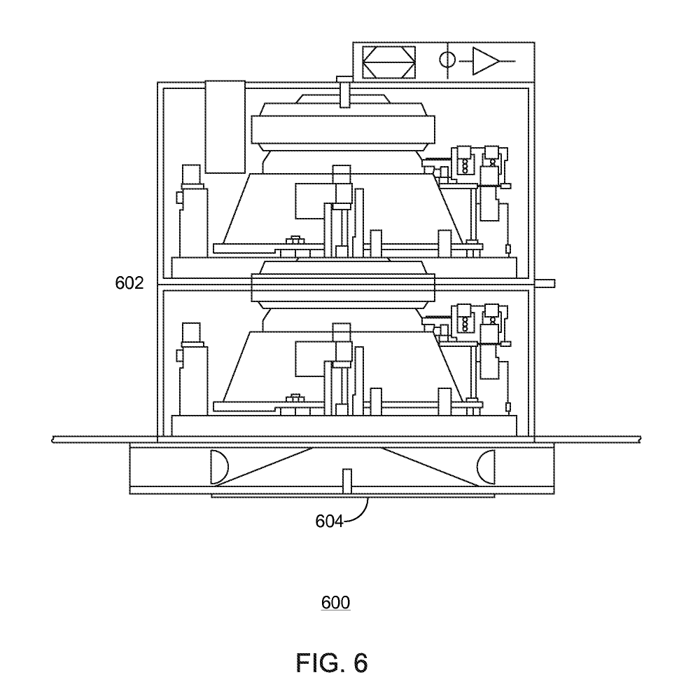

Finally, FIG. 6 shows yet another embodiment of a fixture 600 according to the invention which includes sound system 602 and trim ceiling cap 604. Fixture 600 may be installed for audio use only (but expandable for future lighting and fan use). Such a fixture as shown in the embodiments of the invention in FIGS. 4-6 may be advantageous because the fixtures may utilize a self-contained module to reproduce stereo sound. Also, such fixtures may be closer in design to a lighting fixture in their respective profiles and installation methods. Furthermore, the fixtures may require only an AC connection for both amplifier power and audio signal. In addition, the fixtures can preferably support the addition of a lighting and/or fan kit at some later time, rather than forcing a user to make an irrevocable choice between functionality at the time of purchase. In fact, any of the fixtures shown in FIGS. 4-6 may be advantageous because each one of these fixtures may be marketed as a home-improvement item similar to commercially available ceiling fans and upgrade lighting.

In sum, a fixture according to the invention can be used to retrofit multi-room sound systems. Further advantages according to the invention include the ability to simultaneously upgrade lighting, improve air circulation by adding a ceiling fan, and improve existing multi-room sound distribution in the same endeavor.

Thus, a system that provides a sound system incorporated in a light fixture or other fixture is provided. Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An electrical fixture comprising:
a loudspeaker;
a casing that houses the loudspeaker, the casing further comprising a slot adapted to allow the sound to be transmitted from the loudspeaker to a surrounding area;
a sound diffusor, the sound diffusor that directs sound from the loudspeaker radially outward through the slot; and
a power-line audio and control signal receiver that is adapted to receive an audio signal and a control signal via a power line.

2. The apparatus of claim 1, wherein the loudspeaker comprises two speakers in an isobaric configuration.

3. The apparatus of claim 1 further comprising a plurality of high-frequency sound drivers.

4. The apparatus of claim 1 further comprising a light having an illuminating portion, the slot disposed between the loudspeaker and the illuminating portion of the light.

5. The apparatus of claim 1 further comprising an amplifier.

6. The apparatus of claim 1 further comprising a signal processor.

7. The apparatus of claim 1 further comprising an audio/video source power-line carrier module for transmitting signals from a single source over an electrical network.

8. The apparatus of claim 1 further comprising an audio/video source power-line carrier module enabled subwoofer.

9. The apparatus of claim 1 further comprising an audio/video source power-line carrier module for transmitting signals from a plurality of sources.

10. The apparatus of claim 1 further comprising a fan.

11. An apparatus comprising:
a light, the light further comprising an illuminating portion;
a loudspeaker;
a casing that houses the loudspeaker, the casing further comprising a slot adapted to allow the sound to be transmitted from the loudspeaker to a surrounding area, the slot disposed between the loudspeaker and the illuminating portion of the light; and
a sound diffusor, the sound diffusor that directs sound from the loudspeaker radially outward through the slot.

12. The apparatus of claim 11, wherein the loudspeaker comprises two speakers in an isobaric configuration.

13. The apparatus of claim 11 further comprising a plurality of high-frequency sound drivers.

14. The apparatus of claim 11 further comprising a power-line audio and control signal receiver that is adapted to receive an audio signal and a control signal via a power line.

15. The apparatus of claim 11 further comprising an amplifier.

16. The apparatus of claim 11 further comprising a signal processor.

17. The apparatus of claim 11 further comprising an audio/video source power-line carrier module for transmitting signals from a single source over an electrical network.

18. The apparatus of claim 11 further comprising an audio/video source power-line carrier module enabled subwoofer.

19. The apparatus of claim 11 further comprising an audio/video source power-line carrier module for transmitting signals from a plurality of sources.

20. The apparatus of claim 11 further comprising a fan.

21. An apparatus comprising:
a light, the light further comprising an illuminating portion;
an isobaric pair of loudspeakers;
a casing that houses the loudspeakers, the casing further comprising a slot adapted to allow the sound to be transmitted from the loudspeakers to a surrounding area, the slot disposed between the loudspeakers and the illuminating portion of the light; and
a sound diffusor, the sound diffusor that directs sound from the loudspeaker radially outward through the slot.

22. The apparatus of claim 21 further comprising a plurality of high-frequency sound drivers.

23. The apparatus of claim 21 further comprising a power-line audio and control signal receiver that is adapted to receive an audio signal and a control signal via a power line.

24. The apparatus of claim 21 further comprising an amplifier.

25. The apparatus of claim 21 further comprising a signal processor.

26. The apparatus of claim 21 further comprising an audio/video source power-line carrier module for transmitting signals from a single source over an electrical network.

27. The apparatus of claim 21 further comprising an audio/video source power-line carrier module enabled subwoofer.

28. The apparatus of claim 21 further comprising an audio/video source power-line carrier module for transmitting signals from a plurality of sources.

29. An apparatus comprising:
a fan;
a loudspeaker pair in isobaric configuration;
a casing that houses the loudspeaker pair, the casing further comprising a slot adapted to allow the sound to be transmitted from the loudspeaker pair to a surrounding area, the slot disposed between the loudspeaker pair and the fan; and
a sound diffusor, the sound diffusor that directs sound from the loudspeaker radially outward through the slot.

30. An apparatus comprising:
an isobaric loudspeaker pair;
a casing that houses the loudspeaker pair, the casing further comprising a slot adapted to allow the sound to be transmitted front the loudspeaker pair to a surrounding area; and
a sound diffusor, the sound diffusor that directs sound from the loudspeaker radially outward through the slot.

31. A method for providing audio sound, comprising;
installing in a surface opening a fixture unit comprising:
a light, the light further comprising an illuminating portion, the light being powered by a power line;
a loudspeaker;
a power-line audio and control signal receiver that is adapted to receive an audio signal for the loudspeaker and a control signal to control the operation of the loudspeaker via a power line;
a casing that houses the loudspeaker, the casing further comprising a slot adapted to allow the sound to be transmitted from the loudspeaker to a surrounding area, the slot disposed between the loudspeaker and the illuminating portion of the light; and
a sound diffusor, the sound diffusor that directs sound from the loudspeaker radially outward through the slot.

32. A method for providing audio sound, the method comprising:
installing in a surface opening a fixture unit comprising:
a fan powered by a power line;
a loudspeaker;
a power-line audio and control signal receiver that is adapted to receive an audio signal for the loudspeaker and a control signal to control the operation of the loudspeaker via a power line;
a casing that houses the loudspeaker, the casing further comprising a slot adapted to allow the sound to be transmitted from the loudspeaker to a surrounding area, the slot disposed between the loudspeaker and the fan; and
a sound diffusor, the sound diffusor that directs sound from the loudspeaker radially outward through the slot.
